(19) United States
(12) Patent Application Publication
(10) Pub. No.: US 2007/0208792 A1
(43) Pub. Date: Sep. 6, 2007

(54) METHOD FOR COMPRESSING AND DECOMPRESSING A SEQUENCE OF NUMBERS

(75) Inventors: Robin BERJON, Paris (FR); Gregoire PAU, Paris (FR); Cedric THIENOT, Paris (FR); Claude SEYRAT, Paris (FR)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: EXPWAY, Reims (FR)

(21) Appl. No.: 11/685,467

(22) Filed: Mar. 13, 2007

Related U.S. Application Data
(63) Continuation of application No. PCT/IB05/02723, filed on Sep. 13, 2005.
(60) Provisional application No. 60/608,898, filed on Sep. 13, 2004.

(51) Int. Cl. G06F 7/00

(52) U.S. Cl. 708/207

(57) ABSTRACT

A method for compressing and decompressing sequences of floating-point numbers includes determining a minimum value and a maximum value of the floating point numbers of the sequence, determining a quantization step value as a function of the minimum and maximum values, compressing each floating point number of the sequence by applying to the floating point number a linear quantization between the minimum and maximum values and using the quantization step value, and inserting each compressed value resulting from the compression step in a binary sequence.

### CROSS-REFERENCE TO RELATED APPLICATIONS

This application is a Continuation of International Application No. PCT/IB2005/002723, filed Sep. 13, 2005, which was published in the English language on Mar. 23, 2006, under International Publication No. WO 2006/030288 A2, the disclosure of which is incorporated herein by reference.

### BACKGROUND OF THE INVENTION

Embodiments of the present invention relate in general to the field of computer systems for transmitting, storing, retrieving and displaying data. The present invention more particularly relates to a method and system for compressing and decompressing sequences of floating point numbers.

Many software applications are called upon to transmit, store and retrieve huge amounts of numerical data. This is particularly the case in software applications creating or displaying digital graphical documents such as art, technical drawings, schematics and the like, because these documents include graphical data describing a large number of points, lines and curves. In these graphical documents, graphical objects are described using a language such as SVG (Scalable Vector Graphics) describing two-dimensional vector and mixed vector/raster graphic objects.

SVG is a markup language based on XML (eXtensible Markup Language). It allows three types of graphic objects: vector graphic shapes, images and text. Vector graphic shapes are defined by paths consisting of straight lines and curves. Each line or curve is defined by sequences of segments each comprising coordinates of a start point and an end point and a transformation command defining the shape of the curve linking the start point to the end point. Complex graphic shapes are thus represented in SVG language by long lists of coordinates and transformation commands. According to SVG, all coordinate values are floating numbers digitally encoded with 32 bits according to the IEEE 754 format.

The use of SVG tends to be widely used in particular in mobile telephony to transmit and display graphics on mobile phones. However, the data transfer rates available in mobile telephony are generally reduced and the dimensions of the display on mobile phones are small.

A known solution to reduce the data transfer rate or storage size needed to transmit or store a digital document is to apply a compression process to the document. In this respect, ISO/IEC 15938-1 and more particularly MPEG-7 (Moving Picture Expert Group) proposes a method and a binary format for encoding (compressing) the description of a XML structured document and decoding such a binary format. This standard is more particularly designed to deal with highly structured data, such as multimedia metadata. However, sequences of numbers constitute a significant part of a SVG document. Thus, there is a need to compress sequences of floating point numbers.

Standard compression algorithms such as ZLIB (zip) are not as efficient as expected when applied to sequences of floating point numbers whatever the coding format used to digitally encode such numbers.

Compression methods directed to floating point numbers are disclosed in patents U.S. Pat. No. 6,253,222 and U.S. Pat. No. 6,396,420, the contents of which are incorporated by reference herein. The method disclosed in U.S. Pat. No. 6,253,222 is based on the subtraction of a constant bias value to each floating-point number to be compressed. The method disclosed in U.S. Pat. No. 6,396,420 is based on the identification of common digits in two values to be compressed, the common and non-common parts of the values being compressed separately.

The document “Dynapack: space-time compression of the 3D animations of triangle meshes with fixed connectivity” ACM SIGGRAPH/EUROGRAPHICS SYMPOSIUM ON COMPUTER ANIMATION ASSOC. FOR COMPUT. MACHINERY, IBARRIAL ET AL, pages 126-135, 2003, discloses a compression method for compressing a sequence of floating point numbers based on a linear quantization of the floating point numbers.

### BRIEF SUMMARY OF THE INVENTION

Embodiments of the present invention improve compression efficiency of a sequence of floating-point numbers. Embodiments of the present invention include a compression and decompression method which is adapted to display vector graphical documents such as SVG graphical documents on low resolution displays.

According to the invention, this object is achieved by a compression method for compressing a sequence of floating point numbers includes determining a minimum value (min) and a maximum value (max) of the floating point numbers of the sequence, determining a quantization step value as a function of the minimum and maximum values, compressing each floating point number of the sequence by applying to the floating point number a linear quantization between the minimum and maximum values and using the quantization step value, and inserting each compressed value resulting from the compression step in a binary sequence.

According to a preferred embodiment, each floating point number of the sequence is compressed using the following formula:

$$q = Int [ \frac{v - min}{qstep} ]$$

where v is the floating point number to be compressed, q is the compressed value of number v, min is the minimum value, qstep is the quantization step, and Int[x] is a function returning the integer part of x.

According to a preferred embodiment, the quantization step value is determined using the following formula:

$$qstep = \frac{max - min}{{2}^{nbits} - 2}$$

where nbits is a number of bits of at least one of the compressed values, and max is the maximum value of the floating point numbers of the sequence.

According to a preferred embodiment, the bit number of each of the compressed values is determined as a function of a maximum precision of the floating point numbers.

According to a preferred embodiment, the floating point numbers of the sequence are coordinates of points of a digital graphical image, and the bit number of each of the compressed values is determined as a function of a resolution of a display on which the digital graphical image is intended to be displayed.

According to a preferred embodiment, the compression method includes an initial step of replacing the sequence by a new sequence comprising a first floating point number of the sequence followed by relative numbers, each resulting from a difference between a current and a previous floating point numbers in the sequence, each relative number being compressed using the quantization step value so as to obtain a compressed relative value having a smaller number of bits than the number of bits of the compressed value of the first floating point number.

According to a preferred embodiment, the number of bits of each of the compressed relative numbers is determined using a maximum value of the relative numbers.

According to a preferred embodiment, the floating point numbers of the sequence are coordinates of points, each coordinate comprising at least two floating points, each having a respective coordinate rank, the compression method being applied separately to the floating point numbers of each coordinate rank.

According to a preferred embodiment, the sequence of floating point numbers belongs to a SVG document.

Another object of the invention is a decompression method for decompressing a binary sequence of compressed digital values of floating point numbers. The floating point numbers being comprised between a minimum value and a maximum value. The decompression method includes determining a quantization step value and a bit number of at least one digital value in the binary sequence, reading successively the digital value of each compressed floating point number, using the bit number, and decompressing each digital value read using the quantization step value and the minimum or maximum value, in order to obtain a decompressed value of a floating point number for each digital value read.

According to a preferred embodiment, the decompression includes application of the following formula to each digital value q read:
v=min+qstep·(q+0.5)
where v is the decompressed value of the floating point number, min is the minimum value of the floating point numbers, and qstep is the quantization step.

According to a preferred embodiment, the decompression method further comprises determining the quantization step using the following formula:

$$qstep = \frac{max - min}{{2}^{nbits} - 2}$$

where nbits is the bit number, and max is a maximum value of the floating point numbers.

According to a preferred embodiment, the bit number, the minimum value and the maximum value are determined from a quantization grid identifier provided in a header of the binary sequence.

According to a preferred embodiment, the bit number, the minimum value and the maximum value are provided in a header of the binary sequence.

According to a preferred embodiment, a first digital value in the binary sequence has the bit number, and the other digital values in the binary sequence have a relative bit number smaller than the bit number, each floating point number value being determined by decompressing a current digital value in the binary sequence to obtain a current decompressed value, and adding the current decompressed value to a previous decompressed value. A first floating point number value results from decompression of the first digital value in the binary sequence.

According to a preferred embodiment, the relative bit number is read in a header of the binary sequence.

According to a preferred embodiment, the floating point numbers of the sequence are coordinates of points. Each coordinate comprises at least two floating points, each having a respective coordinate rank. The decompression method being applied separately to the floating point numbers of each coordinate rank.

Embodiments of the invention include a compression device for compressing a sequence of floating point numbers. The compression device includes instructions for determining a minimum value and a maximum value of the floating point numbers of the sequence, instructions for determining a quantization step value as a function of the minimum and maximum values, instructions for compressing each floating point number of the sequence, applying to the floating point number a linear quantization between the minimum and maximum values using the quantization step value, and instructions for inserting each compressed value produced by the compression means in a binary sequence.

According to a preferred embodiment, the compression instructions apply to each floating point number of the sequence the following formula:

$$q = Int [ \frac{v - min}{qstep} ]$$

where v is the floating point number to be compressed, q is the compressed value of number v, min is the minimum value, qstep is the quantization step, and Int[x] is a function returning the integer part of x.

According to a preferred embodiment, the compression device further comprises instructions for replacing the sequence by a new sequence comprising a first floating point number of the sequence followed by relative numbers each resulting from a difference between a current and a previous floating point numbers in the sequence, the compression means compress each relative number using the quantization step value so as to obtain a compressed relative value having a smaller number of bits than the number of bits of the compressed value of the first floating point number.

Embodiments of the invention include a decompression device for decompressing a binary sequence of compressed digital values of floating point numbers. The floating point numbers are between a minimum value and a maximum value. The decompression device includes instructions for determining a quantization step value and a bit number of at least one digital value in the binary sequence, instructions for reading successively the digital value of each compressed floating point number, using the bit number, and instructions for decompressing each digital value read using the quantization step value and the minimum or maximum value, in order to obtain a decompressed value of a floating point number for each digital value read.

According to a preferred embodiment, the decompression instructions apply to each digital value q read the following formula:
v=min+qstep·(q+0.5)
where v is the decompressed value of the floating point number, min is the minimum value of the floating point numbers, and qstep is the quantization step.

According to a preferred embodiment, the decompression device further comprises instructions for determining the quantization step using the following formula:

$$qstep = \frac{max - min}{{2}^{nbits} - 2}$$

where nbits is the bit number, and max is a maximum value of the floating point numbers.

According to a preferred embodiment, the decompression device further comprises instructions for determining the bit number, the minimum value and the maximum value from a quantization grid identifier provided in a header of the binary sequence.

According to a preferred embodiment, a first digital value in the binary sequence has the bit number, and the other digital values in the binary sequence have a relative bit number smaller than the bit number. The decompression instructions determine each floating point number value by decompressing a current digital value in the binary sequence to obtain a current decompressed value, and adding the current decompressed value to a previous decompressed value. A first floating point number value results from decompression of the first digital value in the binary sequence.

According to a preferred embodiment, the decompression device further comprises instructions for reading the relative bit number in a header of the binary sequence.

Embodiments of the invention will be more clearly understood and other features and advantages of the invention will emerge from a reading of the following description given with reference to the appended drawings.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 schematically illustrates a compression device according to the invention;

FIG. 2 schematically illustrates a decompression device according to the invention;

FIG. 3 illustrates a document to be compressed, comprising a sequence of floating point numbers;

FIG. 4 is a flowchart illustrating the compression method according to the present invention;

FIG. 5 illustrates a compressed document comprising a binary sequence of compressed floating point numbers resulting from the compression performed by the compression device of FIG. 1;

FIG. 6 illustrates an alternative part of the compressed document shown in FIG. 3;

FIG. 7 is a flowchart illustrating the decompression method according to the present invention.

### DETAILED DESCRIPTION OF THE INVENTION

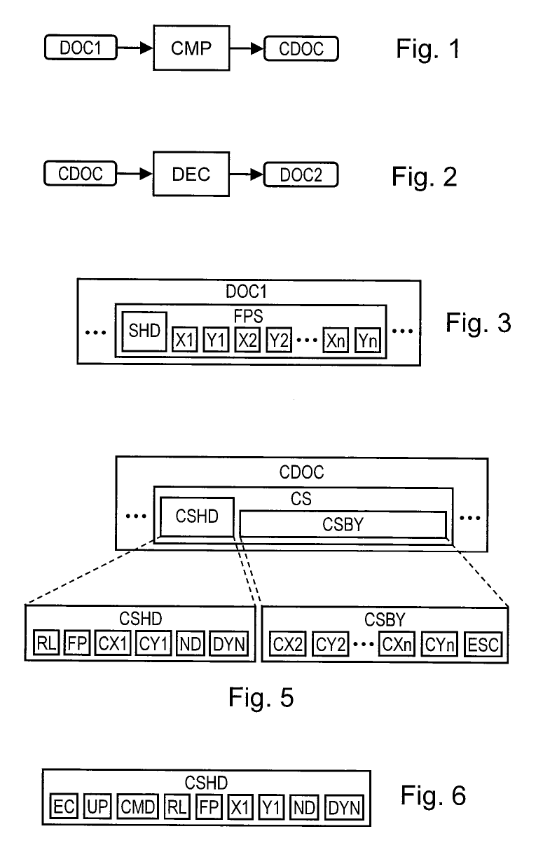

A main characteristic of the invention will now be detailed. FIG. 1 represents a compression device CMP according to the invention. This device is designed to process documents such as digital graphical documents based on SVG language, comprising sequences of floating point numbers. The device CMP produces, from a document DOC1, a compressed document CDOC of smaller size than the document DOC1.

FIG. 2 represents a decompression device DEC adapted to process compressed documents produced by the compression device CMP, and providing decompressed documents. A decompressed document DOC2 produced from a compressed document CDOC by the decompression device is not necessarily identical to the original document DOC1 from which the compression document CDOC has been produced.

FIG. 3 is an example of document DOC1 to be compressed. This document comprises at least one sequence FPS of floating point numbers. This sequence comprises an header SHD and floating points numbers representing for example coordinates (X1, Y1), (X2, Y2) . . . (Xn, Yn) of points of a graphical image. According to SVG language, coordinates are encoded in a floating point format of 32 bits.

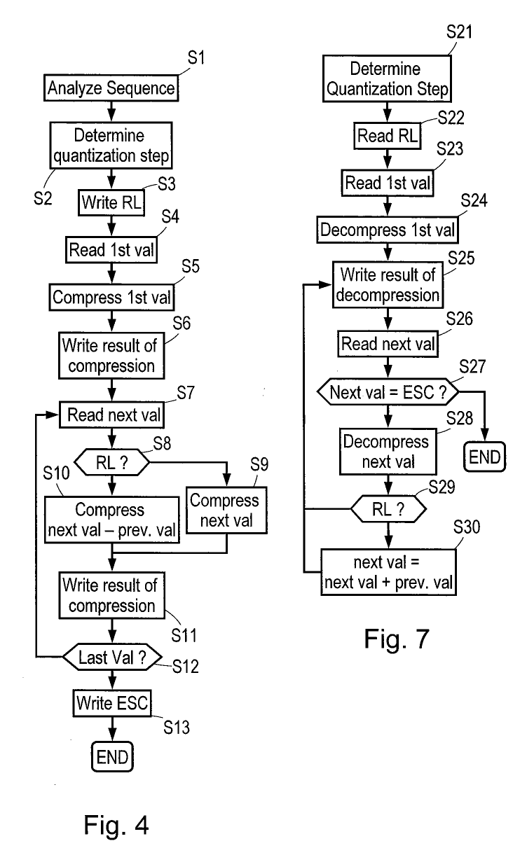

FIG. 4 illustrates the compression method according to embodiments of the invention. This method includes:

S1: analysis of the floating point numbers of the sequence to be compressed;

S2: determination of a quantization step;

S3: insertion of a compression parameter RL in the compressed document;

S4: reading of a first number in the sequence;

S5: compression of the first number;

S6: insertion of the compressed value of the first number in the compressed document;

S7: reading of a next number in the sequence;

S8: test of the compression parameters RL;

S9: compression of the next number;

S10: compression of the difference between the next number and a previous number read in the floating-point sequence;

S11: insertion of the result of the previous compression in the compressed document;

S12: determining if the end of the sequence has been reached; and

S13: insertion of an end code in the compressed document.

At step S1, the sequence FPS of floating-point numbers is analyzed in order to determine compression parameters adapted to a configuration of the floating-point numbers in the sequence. One object of this analysis is to determine minimum and maximum values and the number of significant bits or precision of the floating-point numbers of the sequence.

In a preferred embodiment of the invention, minimum and maximum values are determined from parameters stored in a header of the document DOC1 or the sequence FPS. Such information comprises, for example, the definition of a unit or type of the numbers in the sequence, this unit or type being associated with minimum and maximum values of the floating-point numbers.

In another preferred embodiment of the invention, the minimum and maximum values are determined from the floating-point numbers of the sequence FPS.

The number of significant bits of the floating-point numbers is chosen so as to avoid reducing the maximum precision of the numbers of the sequence. Thus, the compression will be performed without any loss.

In an alternative embodiment of the invention, the number of significant bits is determined with respect to the use of the document. For example, if the document contains a vector graphical image which is intended to be displayed on a low resolution display such as the ones equipping the mobile phones, the number of significant bits of the floating point numbers can be chosen to a value adapted to the resolution of such a display. For example, if the display has a resolution of 320×240 pixels, the bit number can be chosen equal to 9 bits in one dimension and 8 bits in the other dimension. In this case, the compression is irreversible since it introduces losses. However, if the floating-point numbers represent coordinates of points of a vector graphical image, the points of the image will have slightly different positions in the displayed image but the sharpness of the image will not be reduced.

Also at step S1, a maximum difference between the consecutive numbers of the sequence is calculated. This maximum difference is used to determine a compression parameter RL indicating whether a relative compression will be more efficient in terms of compression ratio. For example, if the floating-point numbers of the sequence are coordinates of points of a two-dimension image, and if each point is close to a previous point in the sequence, a relative compression will be more efficient than an absolute one.

If the floating-point numbers of the sequence are arranged in groups where each number has a respective rank such as coordinates, minimum and maximum values and the number of significant bits are determined separately for each rank, i.e., for all the X values and for all the Y values.

At the next step S2 a quantization step “qstep” is determined. To this purpose, the following formula can be applied:

$$qstep = \frac{max - min}{{2}^{nbits} - 2} \qquad ( 1 )$$

where “nbits” is the number of significant bits of the numbers in the sequence FPS, and “max” and “min” are the maximum and minimum values previously determined.

In case the floating-point numbers are coordinates of points in an image, a quantization step is determined for each rank, i.e., for the X values and for the Y values.

At the next step S3, the compression parameter RL is written in the compressed document CDOC.

At the next step S4, the first floating-point number X1 is read in the sequence FPS. This number is then compressed at step S5 by applying thereto a linear quantization between the minimum and maximum values, using the quantization step qstep. The compression consists for example in applying the following formula:

$$q = Int [ \frac{v - min}{qstep} ] \qquad ( 2 )$$

where v is the floating point number to be compressed, q is the compressed value of number v, and Int[x] is a function returning the integer part of x.

At the next step S6, the compressed value obtained is written in the compressed document CDOC. If the floating point numbers represent coordinates of points of a two-dimension image, the first two numbers X1, Y1 of the sequence are read, compressed and inserted in the compressed document at steps S4, S5 and S6.

At the next step S7, the next floating point number is read in the sequence FPS. If the compression is performed in a relative manner according to the compression parameter RL, step S10 is executed. Otherwise step S9 is executed. At step S9, the number read at step S7 is compressed using for example formula (2). At step S10, the compression computation (formula (2) is applied to the difference between the floating-point number read at step S7 and the previous floating-point number (i.e., the first number X1 or Y1 if the currently processed number is the second of the sequence). The result of the relative compression at step S10 comprises a number of significant bits smaller than the result of compression performed at step S9. The number of bit used in relative compression can be either a predefined value or a value determined during the sequence analysis (step S1) as a function of the differences between the numbers of the sequence.

At the following step S11, the compressed value is inserted in the compressed document CDOC. Again, if the floating-point numbers represent coordinates of points of a two-dimension image, two numbers X2, Y2 of the sequence are read, compressed and stored at steps S7-S11.

Then step S12 is executed in order to determine whether the end of the floating point number sequence FPS has been reached. If the end of the sequence has been reached, an end code ESC is inserted in the compressed document (step S13). Otherwise, steps S7 to S12 are executed again.

FIG. 5 illustrates the structure of the compressed document CDOC resulting from the compression of the document DOC1. The compressed document comprises a compressed sequence CS resulting from the compression of sequence FPS. Compressed sequence CS comprises a header CSHD and a body CSBY including the compressed values CX2, CY2 . . . CXn, CYn of the floating-point numbers X2, Y2 . . . Xn, Yn of the sequence.

The header CSHD comprises the compression parameter RL and if the value of RL indicates a relative compression:

a parameter FP indicating if the sequence comprises a first number compressed in an absolute manner;

if parameter FP indicates a first compressed value CX1; and if the floating numbers of the sequence FPS represent coordinates of points; a first compressed value CY1 of a second coordinate Y1;

a compression parameter ND indicating whether the bit number of the relative compressed values is different from a default value; and

if parameter ND indicates a bit number different from the default value; the bit number DYN of the relative compressed values.

FIG. 6 represents the header of a compressed sequence comprising coordinates of points and commands defining the shapes of the lines linking the points. In this case; the header comprises; in addition to the header illustrated in FIG. 5:

a parameter EC indicating if the sequence comprises an explicit command; and

a parameter UP indicating if the command is expressed in uppercase; and a command CMD.

FIG. 7 illustrates a decompression method according to embodiments of the present invention. This method includes:

S21: determination of the quantization step;

S22: reading of compression parameter RL;

S23: reading of a first compressed value CX1 in the compressed sequence CS;

S24: decompression of the first value;

S25: insertion of the decompressed value in the decompressed document DOC2;

S26: reading of a next compressed value in the compressed sequence;

S27: testing whether the next compressed value is equal to an escape code indicating the end of the compressed sequence;

S28: decompression of the next compressed value;

S29: test of the compression parameters RL;

S30: calculation of the difference between the next decompressed value and a previous decompressed value; and

S31: insertion of the decompressed value in the decompressed document DOC2.

At step 21 the quantization step qstep is calculated using formula (1). The number of bits nbits and the maximum and minimum values max and min which are necessary to apply formula (1) are derived from a unit identifier which is read in the compressed sequence header CSHD.

At step S22, the compression parameter RL is read in the compressed sequence header CSHD.

At step S23, a first compressed value CX1 of a floating-point number is read in the compressed sequence CS. This number is then decompressed at step S24 by applying thereto a calculation which is the reverse of the one applied at step S5, using the minimum and maximum values min and max and the quantization step qstep. The decompression consists for example in applying the following formula:
v=min+qstep·(q+0.5) (3)

At step 25, the decompressed value is inserted in a decompressed sequence of the decompressed document DOC2. If the compressed values of the compressed sequence represent coordinates of points, steps 23 to 25 are repeated for each coordinate of a first point.

At step 26, the next value is read in the compressed sequence CS. If the next value is equal to an escape code marking the end of the sequence, the decompression of the sequence is ended (step 27). Otherwise, the next value read at step 26 is decompressed at step 28 by applying the same calculation as the one applied at step 24. If the sequence has been compressed in a relative manner as indicated by compression parameter RL (step 29), the decompression is further performed by multiplying the next value read to the quantization step qstep. The decompressed value inserted in the decompressed document DOC2 is then equal to the decompressed value obtained at step 28 added to the previous decompressed value (step 30):
v(n)=q·qstep+v(n-1) (4)
where v(n) is the next decompressed value, v(n-1) is the previous decompressed value and q is the next value read in the compressed sequence.

Then the decompression process executes steps 25 through 30 for each value of the compressed sequence. If the compressed values of the compressed sequence represent coordinates of points, steps 25, 26, 28 and 30 are repeated for each coordinate.

The decompression process can also be defined by a binary syntax where each data item read in a bitstream or compressed sequence appears in bold and is described by its name, its length in bits, and by a mnemonic for its type and order of transmission. The action triggered by a data item being decompressed from a bitstream depends on the value of the data item and on data item previously read and decompressed. The following constructs are used to express the conditions when data items are present:

while (condition) {
data_item
. . .
}

If the condition is true, the group of data items occurs next in the bitstream. This repeats until the condition ceases to be true. This syntax uses a “C-code” convention according to which a variable or expression evaluated to a non-zero value is equivalent to a true condition and a variable or expression evaluated to a zero value is equivalent to a false condition.

In the following construct, if the condition is true, the first group of data items occurs next in the bitstream. If the condition is false, the second group of data items occurs next in the bitstream:

if (condition) {
data_item
. . .
} else {
data_item
. . .
}

In the following construct, the group of data items occurs (n-m) times. Conditional constructs within the group of data items may depend on the value of the loop control variable i, which is set to m for the first occurrence, incremented by one for the second occurrence, and so forth.

for (i = m; i <n; i++) {
data_item
. . .
}

Function-like constructs are also used in order to pass the value from a certain syntax element or decoding parameter down to another syntax table. The syntax part is defined as a function using C-like syntax, as shown in the following example:

TABLE 1

| | |
|---|---|
| datatype Function(datatype parameter_name) { | Number of bits |
| if (parameter_name = = . . . ) { | |
| OtherFunction(parameter_name) | |
| } else if . . . | |
| . . . | |
| } else { | |
| . . . | |
| } | |
| Return return_value | |
| } | |

This syntax table describes the syntax part called “Function” that receives the parameter “parameter_name” which is of type “datatype”. The parameter “parameter_name” is used within this syntax part, and it can also be passed further to other syntax parts, in the example above to the syntax part “OtherFunction”.

The following syntax tables are another representation of the decompression process illustrated in FIG. 7.

TABLE 2

| | |
|---|---|
| decodeListOfCoordinates (codec) { | Number of bits |
| decodeListOfCoordinatesHeader(codec) | |
| escape = true | |
| while (escape) { | |
| escape = decodeNumber(codec,1) | |
| if(codec.nbDim = ’2’ && !escape) { | |
| decodeNumber(codec,2) | |
| } | |
| } | |
| } | |

Table 2 is the binary syntax table of a decompression function of a compressed sequence of floating point numbers. This function receives the parameter codec which is a complex structure of data comprising “nbits”, “min” and “max” fields defining the number of bits used to encode the compressed values, and the minimum and maximum values of the compressed floating point numbers of the sequence. This function first calls another function “decodeListOfCoordinatesHeader”. Then it initializes a Boolean variable “escape” and enters a loop “while” which executes the followings instructions while the condition “escape” is true. The first instruction of the loop while calls a function “decodeNumber” which reads and decompresses a value in the compressed sequence. This function receives two input parameters “codec” and an integer, and returns a Boolean variable which is stored as the variable “escape”. The next instruction of the loop while tests if the compressed values of the sequence represents coordinates of points in a two-dimensional space. The number of dimensions of the points is stored in the field “nbDim” of the complex variable “codec”. The next instruction calls the function “decodeNumber” if the compressed values are coordinates of points.

The following Table 3 is the binary syntax table of the function “decodeListOfCoordinatesHeader”:

TABLE 3

| | |
|---|---|
| boolean decodeListOfCoordinatesHeader (codec) { | Number of bits |
| codec.relative | 1 |
| if(codec.relative = ‘1’) { | |
| startPoint = ′1′ | |
| if (codec.contextual){ | |
| StartPoint | 1 |
| } | |
| if(startPoint = = 1) { | |
| codec.v(1) = decode(codec.quantizerUsed) | |
| if (codec.nbDim=′2′) { | |
| codec.v(2) = decode(codec.quantizerUsed) | |
| } | |
| } | |
| NewDynamic = 1 | |
| if (codec.contextual) { | |
| NewDynamic | 1 |
| } | |
| if (NewDynamic = = ’1’) { | |
| codec.dynamic | 5 |
| } | |
| } | |
| return startPoint | |
| } | |

The first instruction of function “decodeListOfCoordinatesHeader” reads the compression parameter RL having a length of 1 bit in the compressed sequence and stores it in the field “relative” of the variable “codec”. The next instruction tests the value of the parameter RL. If this parameter is equal to 1, a variable “startPoint” is set to 1. The next instruction tests the value of a field “contextual” of the variable “codec”. If the field “contextual” is set to true, the compression parameter SP coded with one bit is read in the compressed sequence and stored as a variable “startPoint”. If the variable “startPoint” is equal to 1, a function “decode” is called in order to read a first compressed floating point value of the sequence. This function receives as an input parameter “codec.quantizerUsed”, which is a field of the complex variable “codec” and contains the quantization step qstep. The function “decode” reads and decompresses the next value in the compressed sequence and returns the decompressed value which is stored in a field “v(1)” of the complex variable “codec”. If the compressed values represent coordinates of points in a plane (number of dimensions “codec.nbDim”=2), the function “decode” is called again to read and decompress the Y-coordinate of the first point of the compressed sequence. The resulting decompressed value is stored in the field “v(2)” of the complex variable “codec”. Then, a variable “newDynamic” is initialized to 1. The next instruction tests the value of the field “contextual” of the variable “codec”. If the field “contextual” is set to true, the compression parameter ND coded on one bit is read in the compressed sequence CS and stored in the variable “newDynamic”. Then, the value of “newDynamic” is compared to 1, and if it is equal to 1, five bits of the compression parameter DYN are read in the compressed sequence and stored in a field “dynamic” of the complex variable “codec”. The last instruction of function “decodeListOfCoordinatesHeader” specifies that the value of the variable “startpoint” is an output of the function.

Table 4 as follows is the binary syntax table of the function “decodeNumber”:

TABLE 4

| | |
|---|---|
| decodeNumber(codec, index) { | Number of bits |
| if(!codec.relative) { | |
| Num = decode(codec.quantizerUsed) | |
| if (num = = codec.quantizerUsed.escapeCode) { | |
| return false | |
| } | |
| codec.v(index) = num | |
| } else { | |
| escape = readOffset(codec.dynamic,offset) | |
| if (escape) | |
| return false | |
| codec.v(index) += offset *codec.quantizerUsed.step | |
| } | |
| } | |

The function decodeNumber receives as an input parameter the complex variable “codec” and a variable named “index”. The first instruction of this function tests the value of the compression parameter RL stored in the field “codec.relative”. If the compression parameter indicates that the compression is not performed in a relative manner, the function “decode” is called to read and decompress the next value in the sequence CS. The decompressed value is stored in a variable “num” which is then compared with an escape code stored in a field “codec.quantizerUsed.escapeCode” of the variable “codec”. This escape code is the code ESC marking the end of the compressed sequence. If the value read in the compressed sequence is the escape code ESC, the function “decodeNumber” ends and returns a Boolean set to false. The next instruction stores the last decompressed value in the field “v(index)” of the variable “codec”. The following instructions are executed when the compression has been performed in a relative manner. The first instruction calls a function “readOffset” receiving as parameters the field “dynamic” of the variable “codec” and a variable “offset”. The function “readOffset” returns a Boolean indicating whether the end of the sequence has been reached. The value read by the function “readOffset” is returned in the variable “offset”. At the next instruction, the value of the variable “offset” is multiplied by the quantifier step qstep stored in the field “quantizerUsed.step” of the variable “codec” and added to the variable “codec.v(index)”.

Table 5 as follows is the binary syntax table of the function “readOffset”:

TABLE 5

| | |
|---|---|
| boolean readOffset (dynamicity, value) { | Number of bits |
| Negative | 1 |
| Value | dynamicity |
| if (negative = = 1) { | |
| value =− value | |
| } | |
| if (value = = 0 && negative = = 1) { | |
| return true | |
| } else { | |
| return false | |
| } | |
| } | |

This function receives as input parameters a variable “dynamicity” indicating the number of bits to be read in the compressed sequence CS and a variable pointer “value” where the read value must be stored. This function returns a Boolean value. The first instruction of this function reads in the compressed sequence CS a bit indicating if the value to be read is negative, this bit being stored in a variable “negative”. Then this function reads a number of bits equal to “dynamicity”, representing a compressed value in the sequence CS, the value read being stored in the variable “value”. The bit “negative” is then tested and if it indicates a negative value, the variable “value” is set to a negative number. The next instructions of the function test if the value read is an escape code (coded as “−0”) indicating whether the end of the sequence CS is reached, this information being returned as a Boolean by the function.

Table 6 as follows is the binary syntax table of the function “decode”:

TABLE 6

| | |
|---|---|
| float decode (quantizer) { | Number of bits |
| Q | nbits |
| v = quantizer.min + (q + 0.5)*quantizer.step | |
| return v | |
| } | |

This function receives as an input parameter a complex variable “quantizer” containing the minimum value “min” and quantizer step “qstep” used to compress the floating point values of the sequence. This function applies the formula (3) and returns the result of decompression in a floating-point format.

Table 7 as follows is the binary syntax table of a function “decodePath” for decompressing a compressed sequence of floating point numbers representing coordinates of points mixed with commands representing lines or curves between the points.

TABLE 7

| | |
|---|---|
| decodePath( ) { | Number of bits |
| escape = false | |
| firstCoordinate = true | |
| while(!escape) { | |
| explicitCommand | 1 |
| if (explicitCommand = = 1) | |
| Uppercase | 1 |
| Command | 4 |
| } | |
| for (int i = 0; i<(command.nbFollow); i ++) { | |
| if (firstCoordinate) { | |
| startPoint = decodeListOfCoordinatesHeader(spatialgrid) | |
| if (startPoint = = ′0′) { | |
| decodeNumber(spatialgrid,1) | |
| decodeNumber(spatialgrid,2) | |
| } | |
| firstCoordinate = false | |
| } else { | |
| decodeNumber(spatialgrid,1) | |
| decodeNumber(spatialgrid,2) | |
| } | |
| } | |
| if (command = = ′1001′) { | |
| escape = true | |
| } | |
| } | |
| } | |

The first instruction of this function sets to false a variable “escape” and to true a variable “firstCoordinate”. Then this function comprises a loop while having as output condition the value of variable “escape”. The first instruction of the loop reads in the compressed sequence the compression parameter EC (see FIG. 6) coded on one bit, which is stored in a variable “explicitCommand”. Then the value of the variable “explicitCommand” is tested. If this variable is equal to one, the compression parameters UP coded on one bit and CMD coded on four bits are read in the compressed sequence and stored as variables “uppercase” and “command”. The following instructions correspond to a loop for. This loop is repeated a number of times defined by the parameter “command.nbFollow” which is defined in a table. In fact, “command.nbFollow” indicates the number of points following the command “command”. The first instruction of the loop for tests the variable “firstCoordinate”. If “firstCoordinate” is true, the function “decodeListOfCoordinatesHeader” is called and returns an integer “startPoint”. The next instruction tests the value of “startPoint”. If this value is equal to 0, the two next instructions call the function “decodeNumber” to read and decompress the coordinates of a first point. Then the variable “firstCoordinate” is set to false. If “firstCoordinate” is false after the call of the function “decodeListOfCoordinatesHeader”, the coordinates of a next point are read and decompressed by calling the function “decodeNumber” twice. After the end of the loop for, the value of the command “command” is compared with an escape code. If “command” is equal to the escape code, the variable “escape” is set to true in order to end the loop while. In other words, the function “decodePath” reads in the compressed sequence a command and a number of point coordinates depending on the command until the command read is equal to an escape code.

The decompression process of a sequence of floating point numbers and commands can also be defined by the following syntax:

class codec_path {
codec_pointSequence( ) seq;
uivlc5( ) nbOfTypes;
for (int i = 0; i < nbOfTypes; i++) {
uint(5) type[i];
}
}
class codec_pointSequence {
vlc5int nbPoints;
uint(1) flag;
if (flag = = 0) {
if (nbPoints < 3) {
uint(5) bits;
for (int i = 0; i < nbPoints; i++) {
uint(bits) x[i];
uint(bits) y[i];
}
} else {
uint(5) bits;
uint(bits) x[0];
uint(bits) y[0];
uint(5) bitsx;
uint(5) bitsy;
for (int i = 1; i < nbPoints; i++) {
uint(bitsx) dx;
uint(bitsy) dy;
x[i] = dx + x[i−1];
y[i] = dy + y[i−1];
}
}
}
}

This syntax defines two functions “codec_path” and “codec_pointSequence”. The function codec_path first calls the function “codec_pointSequence”. Then it reads an integer of 5 bits in compressed sequence and stores the value read in a variable “nbOfTypes”. The next instruction introduces a loop for which is repeated “nbOfTypes”. The loop for includes an instruction which reads an unsigned integer of 5 bits in the compressed sequence and stores the value read in a table “type”. In other words, the function “codec_path calls the function codec_pointSequence, reads a number “nbOfTypes”, and loads “nbOfTypes” numbers in the table “type”.

The function “codec_pointSequence” first reads integer values of variables “nbPoints” and “flag” having respectively 5 and 1 bits in the compressed sequence. If variable “flag” is not equal to 0, function “codec_pointSequence” performs no operations. Otherwise, the value of variable “nbPoints” is compared with 3. If “nbPoints” is lower than 3, an integer of 5 bits is read in the compressed sequence and stored in a variable “bits”. The next instruction is a loop for reading in the compressed sequence coordinates x and y of a number of points equal to “nbPoints” and loading the values read in tables “x” and “y”. Each coordinate in the compressed sequence is an integer having a number of bits equal to “bits”. If “nbPoints” is greater or equal to 3, an integer of 5 bits is read and stored in the variable “bits”. Then the x- and y-coordinates of a first point are read in the compressed sequence and stored in the tables “x” and “y”. Then two integer numbers having 5 bits are read in the compressed sequence and stored in the variables “bitsx” and “bitsy”. The next instruction introduces a loop for which reads “nbPoints” integer values of variables “dx” and “dy” in the compressed sequence, these variables having respectively “bitsx” and “bitsy” bits. In fact “dx” and “dy” represent relative coordinates of points. The next instructions of the loop for calculate the absolute values of the point coordinates and store these values in tables “x” and “y”.

In fact, the function “codec_pointSequence” presumes that if the number of points in the sequence is less than 3, the coordinates of the points are compressed in an absolute manner. Otherwise these coordinates are compressed in a relative manner. In addition, the number of points in the sequence is written in the compressed sequence instead of using an escape code. When the compression is performed in a relative manner, different numbers of bits “bitsx” and “bitsy” are stored in the compressed sequence for each relative x- and y-coordinate. Then the compressed values of the point coordinates which are stored in tables “x” and “y” are decompressed using formula (3).

Efficiency tests of the compression method according to the invention have shown that the size of the compression result can be lower than 4% of the size of the original document whereas this ratio is greater than 21% when a conventional compression algorithm such as Zlib is used.

Methods of the current invention can be implemented in computer readable instructions and/or computer readable program code.

In the light of the examples described above, it will be clear to those skilled in the art that the method according to the invention is amenable to several variations of implementation and various applications. In this respect, other quantization calculations can be applied and different formulas can be used to calculate the quantization step and the compressed values.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A compression method for compressing a sequence of floating point numbers comprising:
determining a minimum value and a maximum value of the floating point numbers of the sequence;
determining a quantization step value as a function of the minimum and maximum values;
compressing each floating point number of the sequence by applying to the floating point number a linear quantization between the minimum and maximum values and using the quantization step value; and
inserting each compressed value resulting from the compression step in a binary sequence.

2. The compression method according to claim 1, wherein each floating point number of the sequence is compressed using the following formula:
$$q = Int [ \frac{v - min}{qstep} ]$$
where v is the floating point number to be compressed, q is the compressed value of number v, min is the minimum value, qstep is the quantization step, and int[x] is a function returning the integer part of x.

3. The compression method according to claim 2, wherein the quantization step value is determined using the following formula:
$$qstep = \frac{max - min}{{2}^{nbits} - 2}$$
where nbits is a number of bits of at least one of the compressed values, and max is the maximum value of the floating point numbers of the sequence.

4. The compression method according to claim 3, wherein the bit number of each of the compressed values is determined as a function of a maximum precision of the floating point numbers.

5. The compression method according to claim 3, wherein the floating point numbers of the sequence are coordinates of points of a digital graphical image, and the bit number of each of the compressed values is determined as a function of a resolution of a display on which the digital graphical image is intended to be displayed.

6. The compression method according to claim 1, further comprising an initial step of replacing the sequence by a new sequence comprising a first floating point number of the sequence followed by relative numbers, each resulting from a difference between a current and a previous floating point numbers in the sequence, each relative number being compressed using the quantization step value so as to obtain a compressed relative value having a smaller number of bits than the number of bits of the compressed value of the first floating point number.

7. The compression method according to claim 6, wherein the number of bits of each of the compressed relative numbers is determined using a maximum value of the relative numbers.

8. The compression method according to claim 7, wherein the floating point numbers of the sequence are coordinates of points, each coordinate comprising at least two floating points, each having a respective coordinate rank, the compression method being applied separately to the floating point numbers of each coordinate rank.

9. The compression method according to claim 8, wherein the sequence of floating point numbers belongs to a svg document.

10. A decompression method for decompressing a binary sequence of compressed digital values of floating point numbers, the floating point numbers being comprised between a minimum value and a maximum value, the decompression method comprising:
determining a quantization step value and a bit number of at least one digital value in the binary sequence;
reading successively the digital value of each compressed floating point number; using the bit number; and
decompressing each digital value read using the quantization step value and the minimum or maximum value, in order to obtain a decompressed value of a floating point number for each digital value read.

11. The decompression method according to claim 10, wherein the decompression step comprises the application of the following formula to each digital value q read:
v=min+qstep·(q+0.5)
where v is the decompressed value of the floating point number, min is the minimum value of the floating point numbers, and qstep is the quantization step.

12. The decompression method according to claim 10, further comprising a step of determining the quantization steps using the following formula:
$$qstep = \frac{max - min}{{2}^{nbits} - 2}$$
where nbits is the bit number, and max is a maximum value of the floating point numbers.

13. The decompression method according to claim 12, wherein the bit number, the minimum value and the maximum value are determined from a quantization grid identifier provided in a header of the binary sequence.

14. The decompression method according to claim 12, wherein the bit number, the minimum value and the maximum value are provided in a header of the binary sequence.

15. The decompression method according to claim 14, wherein a first digital value in the binary sequence has the bit number, and the other digital values in the binary sequence have a relative bit number smaller than the bit number, each floating point number value being determined by:
decompressing a current digital value in the binary sequence to obtain a current decompressed value; and
adding the current decompressed value to a previous decompressed value, a first floating point number value resulting from decompression of the first digital value in the binary sequence.

16. The decompression method according to claim 14, wherein the relative bit number is read in a header of the binary sequence.

17. The decompression method according to claim 16, wherein the floating point numbers of the sequence are coordinates of points, each coordinate comprising at least two floating points each having a respective coordinate rank, the decompression method being applied separately to the floating point numbers of each coordinate rank.

18. The decompression method according to claim 17, wherein the sequence of floating point numbers belongs to a svg document.

19. A compression device for compressing a sequence of floating point numbers comprising:
means for determining a minimum value and a maximum value of the floating point numbers of the sequence;
means for determining a quantization step value as a function of the minimum and maximum values;
means for compressing each floating point number of the sequence, applying to the floating point number a linear quantization between the minimum and maximum values using the quantization step value; and
means for inserting each compressed value produced by the compression means in a binary sequence.

20. The compression device according to claim 19, wherein the compression means apply to each floating point number of the sequence the following formula:
$$q = Int [ \frac{v - min}{qstep} ]$$
where v is the floating point number to be compressed, q is the compressed value of number v, min is the minimum value, qstep is the quantization step, and int[x] is a function returning the integer part of x.

21. The compression device according to claim 20, wherein the quantization step value is determined using the following formula:
$$qstep = \frac{max - min}{{2}^{nbits} - 2}$$
where nbits is a number of bits of at least one of the compressed values, and max is the maximum value of the floating point numbers of the sequence.

22. The compression device according to claim 21, wherein the bit number of each of the compressed values is determined as a function of a maximum precision of the floating point numbers.

23. The compression device according to claim 21, wherein the floating point numbers of the sequence are coordinates of points of a digital graphical image, and the bit number of each of the compressed value is determined as a function of a resolution of a display on which the digital graphical image is intended to be displayed.

24. The compression device according to claim 23, comprising means for replacing the sequence by a new sequence comprising a first floating point number of the sequence followed by relative numbers each resulting from a difference between a current and a previous floating point numbers in the sequence, the compression means compress each relative number using the quantization step value so as to obtain a compressed relative value having a smaller number of bits than the number of bits of the compressed value of the first floating point number.

25. The compression device according to claim 24, wherein the number of bits of each of the compressed relative numbers is determined using a maximum value of the relative numbers.

26. The compression device according to claim 25, wherein the floating point numbers of the sequence are coordinates of points, each coordinate comprising at least two floating points each having a respective coordinate rank, the compression being applied separately to the floating point numbers of each coordinate rank.

27. The compression device according to claim 26, wherein the sequence of floating point numbers belongs to a svg document.

28. A decompression device for decompressing a binary sequence of compressed digital values of floating point numbers, the floating point numbers being comprised between a minimum value and a maximum value, the decompression device comprising:
means for determining a quantization step value and a bit number of at least one digital value in the binary sequence;
means for reading successively the digital value of each compressed floating point number, using the bit number; and
means for decompressing each digital value read using the quantization step value and the minimum or maximum value, in order to obtain a decompressed value of a floating point number for each digital value read.

29. The decompression device according to claim 28, wherein the decompression means apply to each digital value q read the following formula:
v=min+qstep·(q+0.5)
where v is the decompressed value of the floating point number, min is the minimum value of the floating point numbers, and qstep is the quantization step.

30. The decompression device according to claim 28, further comprising means for determining the quantization step using the following formula:
$$qstep = \frac{max - min}{{2}^{nbits} - 2}$$
where nbits is the bit number, and max is a maximum value of the floating point numbers.

31. The decompression device according to claim 30, further comprising means for determining the bit number, the minimum value and the maximum value from a quantization grid identifier provided in a header of the binary sequence.

32. The decompression device according to claim 30, wherein the bit number, the minimum value and the maximum value are provided in a header of the binary sequence.

33. The decompression device according to claim 28, wherein a first digital value in the binary sequence has the bit number, and the other digital values in the binary sequence have a relative bit number smaller than the bit number, the decompression means determining each floating point number value by:
decompressing a current digital value in the binary sequence to obtain a current decompressed value; and
adding the current decompressed value to a previous decompressed value, a first floating point number value resulting from decompression of the first digital value in the binary sequence.

34. The decompression device according to claim 32, further comprising means for reading the relative bit number in a header of the binary sequence.

35. The decompression device according to claim 28, wherein the floating point numbers of the sequence are coordinates of points, each coordinate comprising at least two floating points each having a respective coordinate rank, the decompression being applied separately to the floating point numbers of each coordinate rank.

36. The decompression device according to anyone of claim 35, wherein the sequence of floating point numbers belongs to a svg document.

37. A compression device for compressing a sequence of floating point numbers having computer readable instructions comprising:
determining a minimum value and a maximum value of the floating point numbers of the sequence;
determining a quantization step value as a function of the minimum and maximum values;
compressing each floating point number of the sequence by applying to the floating point number a linear quantization between the minimum and maximum values and using the quantization step value; and
inserting each compressed value resulting from the compression step in a binary sequence.

38. A decompression device for decompressing a string sequence of compressed digital values of floating point numbers, the floating point numbers being comprised between a minimum value and a maximum value, the decompression device having computer readable instructions comprising:
determining a quantization step value and a bit number of at least one digital value in the binary sequence;
reading successively the digital value of each compressed floating point number; using the bit number; and
decompressing each digital value read using the quantization step value and the minimum or maximum value, in order to obtain a decompressed value of a floating point number for each digital value read.
